(19) United States
(12) Patent Application Publication
(10) Pub. No.: US 2021/0179098 A1
(43) Pub. Date: Jun. 17, 2021

(54) VEHICLE AND METHOD OF CONTROLLING THE SAME

(71) Applicants: HYUNDAI MOTOR COMPANY, Seoul (KR); KIA MOTORS CORPORATION, Seoul (KR)

(72) Inventors: Hayeon Lee, Gwacheon-si (KR); Jinwook Choi, Seoul (KR); Jongmo Kim, Goyang-si (KR); Junsik An, Seoul (KR); Minsung Son, Gwacheon-si (KR)

(73) Assignees: HYUNDAI MOTOR COMPANY, Seoul (KR); KIA MOTORS CORPORATION, Seoul (KR)

(21) Appl. No.: 16/996,613

(22) Filed: Aug. 18, 2020

(30) Foreign Application Priority Data
Dec. 12, 2019 (KR) 10-2019-0166112

(51) Int. Cl. B60W 30/095; B60W 40/04

(52) U.S. Cl. CPC B60W 30/0956; B60W 2420/54; B60W 2554/4041; B60W 40/04

(57) ABSTRACT

A vehicle and a method are capable of efficient autonomous parking by forming an occupancy map and a probability map using a camera and an ultrasonic sensor, and a method of controlling the vehicle. The vehicle includes: a camera disposed in a vehicle to have a plurality of channels and configured to obtain an image from around the vehicle; a sensing device including an ultrasonic sensor and configured to obtain distance information between an object and the vehicle; and a controller. The controller is configured to match the distance information with the image from around the vehicle, to divide the image from around the vehicle into a plurality of areas, to determine a risk of each of the plurality of areas by matching the object included in the plurality of areas to a predetermined class, and to form a probability map and an occupancy map corresponding to the image from around the vehicle based on the risk.

### CROSS-REFERENCE TO RELATED APPLICATION(S)

This application is based on and claims priority under 35 U.S.C. § 119 to Korean Patent Application No. 10-2019-0166112, filed on Dec. 12, 2019 in the Korean Intellectual Property Office, the disclosure of which is incorporated by reference in its entirety.

### TECHNICAL FIELD

The disclosure relates to a vehicle for recognizing an image from around the vehicle, and a method of controlling the vehicle.

### BACKGROUND

An autonomous driving technology of a vehicle is a technology in which the vehicle grasps a road condition and automatically drives even if a driver does not control a brake, a steering wheel, or an accelerator pedal.

The autonomous driving technology is a core technology for smart car implementation. For autonomous driving, the autonomous driving technology may include highway driving assist (HDA, a technology that automatically maintains a distance between vehicles), blind spot detection (BSD, a technology that detects surrounding vehicles during reversing and sounds an alarm), autonomous emergency braking (AEB, a technology that activates a braking system when the vehicle does not recognize a preceding vehicle), lane departure warning system (LDWS), lane keeping assist system (LKAS, a technology that compensates for departing the lane without turn signals), advanced smart cruise control (ASCC, a technology that maintains a constant distance between vehicles at a set speed and drives at a constant speed driving), traffic jam assistant (TJA), parking collision-avoidance assist (PCA), and remote smart parking assist (RSPA).

In particular, the RSPA system uses only an ultrasonic sensor for a parking space recognition, so it is possible to perform automatic parking by generating a control trajectory only when the vehicle is nearby.

In order to increase the completeness of the parking space without the vehicle or a parking arrangement, there is a need for a recognition system that recognizes lane types outside the vehicle and transmits the lane types to a control system.

### SUMMARY

An aspect of the disclosure is to provide a vehicle capable of efficient autonomous parking driving by forming an occupancy map and a probability map using a camera and an ultrasonic sensor, and a method of controlling the vehicle. Parking driving, as used herein, may refer to a vehicle that is driving or being driven in order to park or attempt to park the vehicle in a parking lot or parking area.

Additional aspects of the disclosure are set forth in part in the description which follows and, in part, should be apparent from the description or may be learned by practice of the disclosure.

In accordance with an aspect of the disclosure, a vehicle includes a camera disposed in a vehicle to have a plurality of channels and configured to obtain an image from around the vehicle; a sensing device including an ultrasonic sensor and configured to obtain distance information between an object and the vehicle; and a controller configured to match the distance information with the image from around the vehicle, to divide the image from around the vehicle into a plurality of areas, to determine a risk of each of the plurality of areas by matching the object included in the plurality of areas to a predetermined class, and to form a probability map and an occupancy map corresponding to the image from around the vehicle based on the risk.

The controller may be configured to assign a weight to the object included in the plurality of areas, and to determine the risk based on a weight value.

The controller may be configured to determine a risk probability corresponding to each area based on a relative risk between the plurality of areas, and to form the probability map based on the risk probability.

When a distance between the vehicle and the object is less than a predetermined distance, the controller may be configured to determine the risk probability based on a signal obtained by the ultrasonic sensor.

The controller may be configured to determine an update cycle of the ultrasonic sensor signal based on position information of the object.

The controller may be configured to match the risk probability to the image from around the vehicle by corresponding to a predetermined scale.

The controller may be configured to guide a moving path of the vehicle based on the probability map.

The controller may be configured to form a top view shape using the occupancy map and the probability map formed corresponding to the image from around the vehicle obtained from each of the plurality of channels of the camera.

In accordance with another aspect of the disclosure, a method of controlling a vehicle includes obtaining, by a camera having a plurality of channels, an image from around the vehicle; obtaining, by a sensing device including an ultrasonic sensor, distance information between an object and the vehicle; matching, by a controller, the distance information with the image from around the vehicle; dividing, by the controller, the image from around the vehicle into a plurality of areas; determining, by the controller, a risk of each of the plurality of areas by matching the object included in the plurality of areas to a predetermined class; and forming, by the controller, a probability map and an occupancy map corresponding to the image from around the vehicle based on the risk.

The determining of the risk of each of the plurality of areas may include assigning a weight to the object included in the plurality of areas; and determining the risk based on a weight value.

The forming of the probability map may include determining a risk probability corresponding to each area based on a relative risk between the plurality of areas; and forming the probability map based on the risk probability.

The determining of the risk probability may include determining the risk probability based on a signal obtained by the ultrasonic sensor when a distance between the vehicle and the object is less than a predetermined distance.

The method may further include determining, by the controller, an update cycle of the ultrasonic sensor signal based on position information of the object.

The method may further include matching, by the controller, the risk probability to the image from around the vehicle by corresponding to a predetermined scale.

The method may further include guiding, by the controller, a moving path of the vehicle based on the probability map.

The method may further include forming, by the controller, a top view shape using the occupancy map and the probability map formed corresponding to the image from around the vehicle obtained from each of the plurality of channels of the camera.

### BRIEF DESCRIPTION OF THE DRAWINGS

These and/or other aspects of the disclosure will become apparent and more readily appreciated from the following description of the embodiments, taken in conjunction with the accompanying drawings of which:

FIG. 1 is a control block diagram according to an embodiment.

FIG. 2 is a view illustrating a relationship between an image from around a vehicle obtained from a camera of each channel, an occupancy map, and a probability map according to an embodiment.

FIG. 3 is a view illustrating an image from around a vehicle and a plurality of areas according to an embodiment.

FIG. 4 is a view for describing a relationship between a predetermined class and an image from around a vehicle according to an embodiment.

FIG. 5 is a view for describing an operation of determining an update cycle of an ultrasonic sensor signal based on position information of an object according to an embodiment.

FIG. 6 is a view for describing a scale representing a risk probability according to an embodiment.

FIG. 7 is a view illustrating forming an occupancy map according to an embodiment.

FIG. 8 is a view illustrating forming a top view through occupancy maps obtained from a plurality of channels of a camera according to an embodiment.

FIG. 9 is a flowchart according to an embodiment.

### DETAILED DESCRIPTION

Identical reference numerals refer to identical or equivalent elements throughout the specification. Not all elements of the embodiments of the disclosure are described, and the description of elements commonly known in the art or that overlap with each other in the embodiments has been omitted. The terms as used throughout the specification, such as “˜part,” “˜module,” “˜member,” “˜block,” etc., may be implemented in software and/or hardware, and a plurality of “˜parts,” “˜modules,” “˜members,” or “˜blocks” may be implemented in a single element, or a single “˜part,” “˜module,” “˜member,” or “˜block” may include a plurality of elements. When a part, module, member, block, component, device, element, or the like of the present disclosure is described as having a purpose or performing an operation, function, or the like, the part, module, member, block, component, device, or element should be considered herein as being “configured to” meet that purpose or to perform that operation function. Further, the controller described herein may include a processor programmed to perform the noted operation, function, operation, or the like.

It should be further understood that the term “connect” and its derivatives refer both to direct and indirect connection, and the indirect connection includes a connection over a wireless communication network. The terms “include (or including)” and “comprise (or comprising)” are inclusive or open-ended and do not exclude additional, unrecited elements or method steps, unless otherwise mentioned. It should be further understood that the term “member” and its derivatives refer both to when a member is in contact with another member and when another member exists between the two members. It should be understood that, although the terms first, second, third, etc., may be used herein to describe various elements, components, regions, layers, and/or sections, these elements, components, regions, layers, and/or sections should not be limited by these terms. These terms are only used to distinguish one element, component, region, layer, or section from another element, component, region, layer, or section.

It should be understood that the singular forms “a,” “an,” and “the” include plural references unless the context clearly dictates otherwise. Reference numerals used for method steps are merely used for convenience of explanation, but not to limit an order of the steps. Thus, unless the context clearly dictates otherwise, the written order may be practiced otherwise.

Hereinafter, an operation principle and embodiments of the disclosure is described with reference to accompanying drawings.

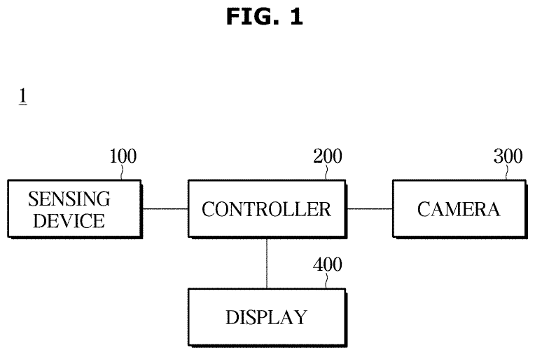

FIG. 1 is a control block diagram according to an embodiment.

Referring to FIG. 1, a vehicle 1 according to an embodiment may include a camera 300, a sensing device 100, a display 400, and a controller 200.

The camera 300 has a plurality of channels and may obtain images from around the vehicle 1, i.e., of the vehicle's surroundings.

The camera 300 installed in the vehicle 1 may include a charge-coupled device (CCD) camera or a CMOS color image sensor. Here, both the CCD and the CMOS refer to a sensor that converts light received through the lens of the camera 101 into an electric signal and stores the electric signal.

The sensing device 100 may include an ultrasonic sensor.

The ultrasonic sensor may employ a method of transmitting ultrasonic waves and detecting a distance to an obstacle using the ultrasonic waves reflected on the obstacle.

The sensing device 100 may obtain distance information of the vehicle 1 and the obstacle provided around the vehicle 1.

The display 400 may be provided as an instrument panel provided in the vehicle 1 or a display device provided in a center fascia.

The display 400 may include cathode ray tubes (CRTs), a digital light processing (DLP) panel, a plasma display panel (PDP), a liquid crystal display (LCD) panel, an electro luminescence (EL) panel, an electrophoretic display (EPD) panel, an electrochromic display (ECD) panel, a light emitting diode (LED) panel or an organic light emitting diode (OLED) panel, but is not limited thereto.

The controller 200 may match the distance information with an image from around the vehicle 1 and may divide the image from around the vehicle 1 into a plurality of areas.

The plurality of areas may cover the area in which the obstacle exists among the images from around the vehicle 1.

The controller 200 may determine a risk of each of the plurality of areas in response to a predetermined class of objects included in the plurality of areas.

The predetermined class may refer to a kind of the object included in each of the areas. A detailed description related to this is described in detail in the corresponding drawings.

The controller 200 may form a probability map and an occupancy map corresponding to the image from around the vehicle 1 based on the risk.

The controller 200 may assign a weight to the object included in the plurality of areas and determine the risk based on a weight value.

The weight may be assigned according to the above-mentioned class.

The controller 200 may determine the risk corresponding to each object by adding up the weight value corresponding to each object.

The controller 200 may determine a risk probability corresponding to each of the areas based on relative risks between the areas.

The risk is a value determined based on the weight corresponding to each of the areas, whereas the risk probability is a relative concept of the risk of each of the areas.

For example, a free space, where the object does not exist in the image of the vehicle 1, may be assigned the risk probability of 0%. A detailed description related to this is described later.

When the distance between the vehicle 1 and the object is less than a predetermined distance, the controller 200 may determine the risk probability based on the signal obtained by the ultrasonic sensor.

The distance at which the ultrasonic signal can be obtained is limited. According to the embodiment, the controller 200 may obtain information using the image from around the vehicle 1 and the ultrasonic sensor at the same time in a case of the object located within 3 m from the vehicle 1.

The controller 200 may determine an update cycle of an ultrasonic sensor signal based on position information of the object.

Particularly, when it is determined that the object is located in the corresponding part, the controller 200 may determine the update cycle of the information around the object to be shorter than the update cycle of the information farther away from the object.

The controller 200 may match the risk probability with a predetermined scale to match the image from around the vehicle 1. As described below, the scale may be determined with a predetermined gray scale.

The controller 200 may guide a moving path of the vehicle 1 based on the probability map. Since the probability map includes information of the object having a possibility of collision of the vehicle 1, the controller 200 may guide the vehicle 1 so as not to collide with the object based on the information of the object.

The controller 200 may form a top view shape using the occupancy map and the probability map formed corresponding to the image from around the vehicle 1 obtained from each of the plurality of channels of the camera 300.

In addition, the controller 200 may output the top view image to the display 400 described above.

The controller 200 may be implemented with a memory storing an algorithm to control operation of the components in the vehicle 1 or data about a program that implements the algorithm, and a processor carrying out the aforementioned operation using the data stored in the memory. The memory and the processor may be implemented in separate chips. Alternatively, the memory and the processor may be implemented in a single chip.

At least one component may be added or deleted corresponding to the performance of the components of the vehicle 1 illustrated in FIG. 1. It should be readily understood by those having ordinary skill in the art that the mutual position of the components may be changed corresponding to the performance or structure of the vehicle 1.

In the meantime, each of the components illustrated in FIG. 1 may be referred to as a hardware component such as software and/or a field programmable gate array (FPGA) and an application specific integrated circuit (ASIC).

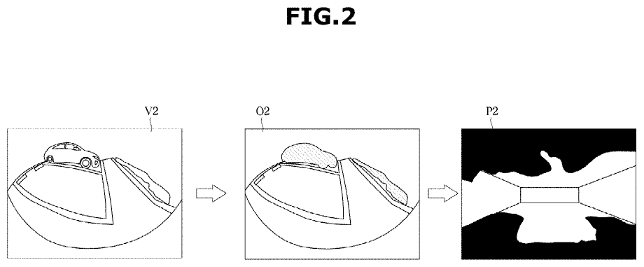

FIG. 2 is a view illustrating a relationship between an image from around a vehicle obtained from a camera of each channel, an occupancy map, and a probability map according to an embodiment.

Referring to FIG. 2, the image obtained by the camera 300 may be classified as the object and a road and displayed.

The controller 200 may perform a pre-learned Semantic Segmentation algorithm by receiving a 4-channel image input from the camera 300 in recognizing object information.

The controller 200 may recognize a free space and obstacle information V2 from around the vehicle 1.

In addition, based on the obtained information, the controller 200 may determine whether the object occupies a space, and may form an occupancy map 02 based on this.

It is also possible to form a probability map P2 based on a relative risk probability of the object.

In forming the occupancy map 02 and the probability map P2, the image formed by each channel of the camera 300 may be synthesized. Hereinafter, an operation in which the operation is formed is described in detail in steps.

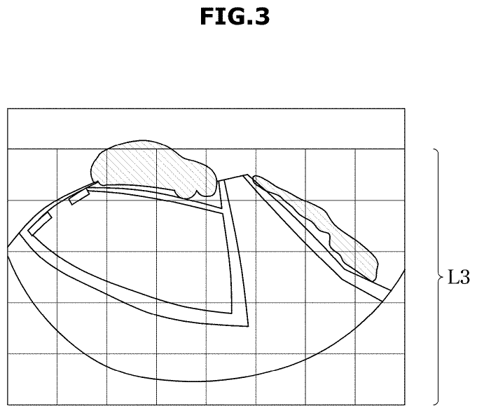

FIG. 3 is a view illustrating an image from around a vehicle and a plurality of areas according to an embodiment.

The controller 200 may divide the image obtained by the camera 300 into a predetermined area.

According to the embodiment, the obstacle exists up to a L3 area in the image from around the vehicle 1, and the predetermined area may be allocated to an image up to the corresponding area. According to the embodiment, the controller 200 may allocate the area of the image recognition result based on a real distance.

The area may be allocated by setting one area to 20 cm×20 cm.

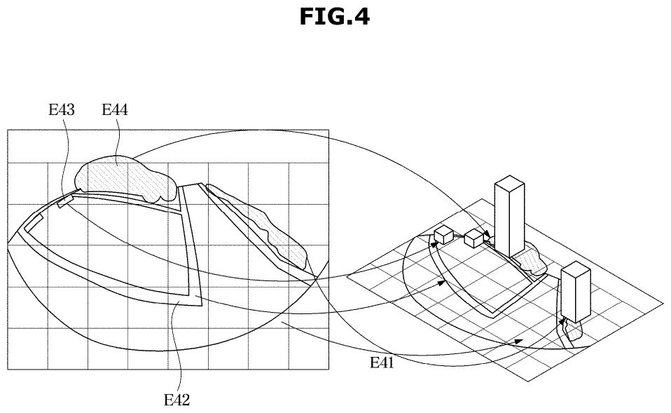

FIG. 4 is a view for describing a relationship between a predetermined class and an image from around a vehicle according to an embodiment.

Referring to FIG. 4, it is illustrated that the image from around the vehicle 1 described in FIG. 3 is matched with the predetermined area.

On the other hand, the predetermined class according to the embodiment may be determined as an empty space E41 and a space E42 where the vehicle 1 such as a parking line can pass, a space E43 where the vehicle 1 can pass if necessary, such as a stopper and a curb, a space E44 that cannot be crossed by the vehicle 1 such as a pillar, an obstacle, another vehicle, or other objects.

The controller 200 may assign the weight value of 0 to a class corresponding to the space in which the vehicle 1 can pass.

If necessary, the controller 200 may assign a low weight to the space in which the vehicle 1 can pass.

On the other hand, a high weight may be given to the space that the vehicle 1 cannot pass.

Meanwhile, the controller 200 may determine the risk by summing the weights for each class.

For example, in the case of E44, the object occupying the area may be determined to be another vehicle. Since the other vehicle corresponds to the space in which the vehicle 1 cannot pass, the controller 200 may determine the risk by assigning the high weight and summing all the weights of the corresponding area.

The controller 200 may determine a high risk for E44. Also, in determining the risk, it can be determined that the larger the area occupied by the class with a large weight, the higher the risk.

On the other hand, in the case of E41, since the corresponding area is opposed to the area in which the vehicle 1 can move to an empty space, the controller 200 may assign the weight of 0 and determine that the risk is low.

Meanwhile, the controller 200 may determine the risk probability corresponding to each of the areas based on the relative risk between the areas. Particularly, the controller 200 may determine that the risk probability is high because the E44 has the higher risk than the E41.

The controller 200 may determine the probability map based on the risk probability determined by the operation.

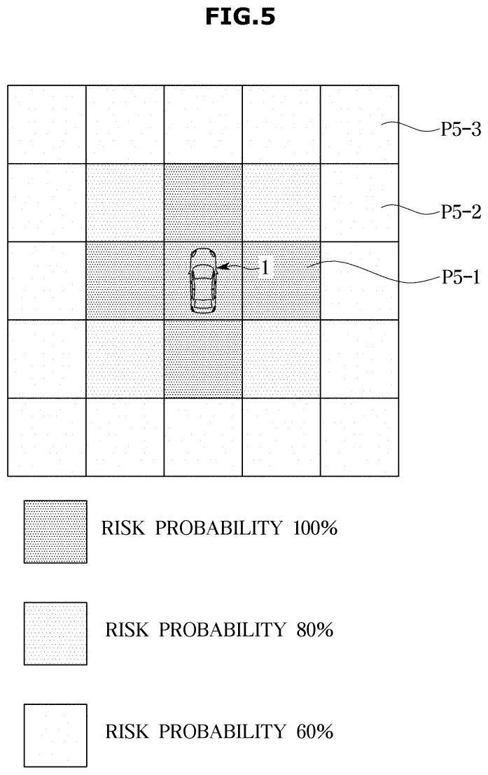

FIG. 5 is a view for describing an operation of determining the update cycle of the ultrasonic sensor signal based on position information of an object according to an embodiment.

Referring to FIG. 5, P5 may refer to a position where the object obtained by the vehicle 1 exists.

The controller 200 may determine the update cycle of the ultrasonic sensor signal based on the position information of the object.

Particularly, since an area P5-1 around the object has a high probability of collision, a sensor update cycle of the ultrasonic sensor may be shortly determined.

On the other hand, since an area P5-2 where the object is located has a low probability of collision, the sensor update cycle of the ultrasonic sensor may be long.

In other words, the controller 200 may obtain a lot of information by determining a short update cycle in the area close to the determined object and may obtain less information by determining a long update cycle of the object and a distant area. Through this operation, the controller 200 may perform efficient information management.

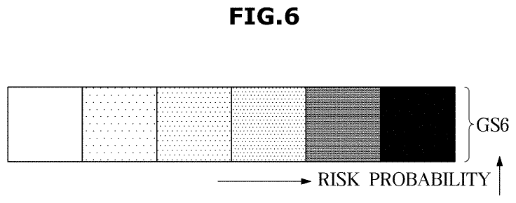

FIG. 6 is a view for describing a scale representing a risk probability according to an embodiment.

The scale may be provided with a predetermined gray scale GS6.

When the risk probability of the corresponding area is high, the controller 200 may form the probability map by displaying the corresponding surrounding image on a scale close to black.

On the other hand, when the risk probability of the corresponding area is low, the controller 200 may form the probability map by displaying the corresponding surrounding image on the scale close to white.

Meanwhile, the scale described in FIG. 6 is only the embodiment of the disclosure, and there is no limitation in a display form of the scale.

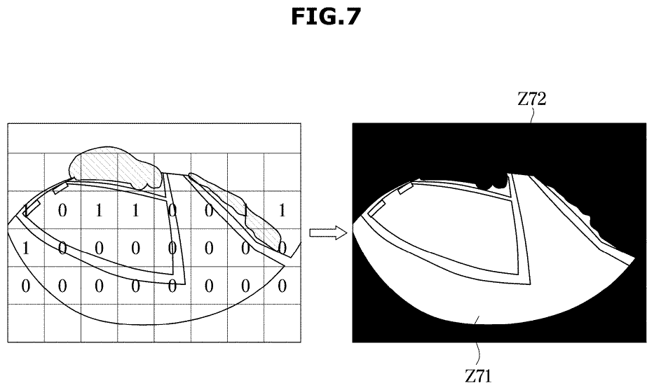

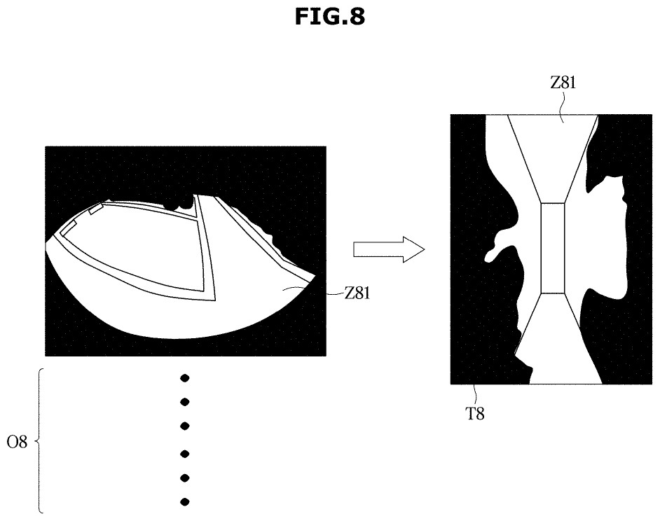

FIG. 7 is a view illustrating forming an occupancy map according to an embodiment, and FIG. 8 is a view illustrating forming a top view through occupancy maps obtained from a plurality of channels of a camera according to an embodiment.

The controller 200 may form the occupancy map using the risk of each of the areas. When the risk of the corresponding area is 0, the controller 200 may determine that the corresponding area is not occupied and display the corresponding area as 0. In FIG. 7, since a Z71 area corresponds to the empty space, the controller 200 may assign 0 to the corresponding area.

On the other hand, when the risk of the corresponding area is not 0, the controller 200 may determine that the corresponding area is an occupied area Z72 and display the corresponding area as 1.

The controller 200 may generate the occupancy map using an unoccupied area as a movable region based on this.

FIG. 8 illustrates that a top view T8 may be formed through an occupancy map O8 obtained from the plurality of channels of the camera 300 according to the embodiment.

The controller 200 may form the occupancy map O8 based on the image obtained by the camera 300 based on the above-described operation.

According to the embodiment, since the camera 300 may include four channels, the occupancy map O8 may be formed from each image obtained from each of the channels.

The controller 200 may synthesize each occupancy map thus formed to form a top view image T8.

On the other hand, in the top view image formed by the controller 200, it is determined that there is no obstacle in a Z81 area, so the controller 200 may avoid the collision by guiding the vehicle 1 to drive to the corresponding area.

In addition, the controller 200 may output the top view image formed by the operation to the display 400.

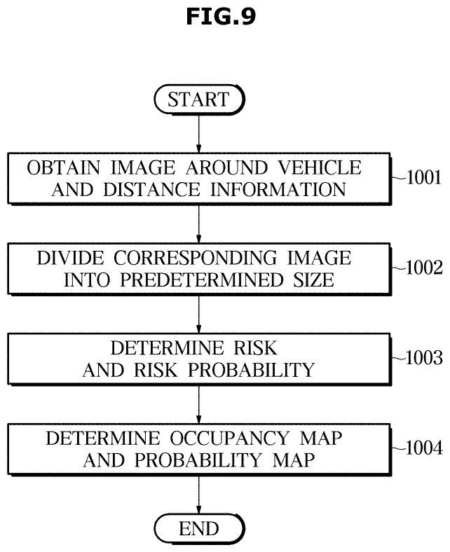

FIG. 9 is a flowchart according to an embodiment.

Referring to FIG. 9, the controller 200 may obtain the image from around the vehicle 1 and the distance information (1001).

In addition, the controller 200 may divide the corresponding image into an area of a predetermined size (1002).

The controller 200 may determine the risk and risk probability of the corresponding area based on the information obtained by the ultrasonic sensor and the image from around the vehicle 1 obtained by the camera 300 (1003).

In addition, the occupancy map may be formed as the risk, and the probability map may be formed based on the risk probability (1004).

According to the embodiments of the disclosure, the vehicle and the method of controlling the vehicle may form the occupancy map and the probability map using the camera and the ultrasonic sensor, thereby enabling efficient autonomous parking driving.

The disclosed embodiments may be implemented in the form of a recording medium storing computer-executable instructions that are executable by a processor. The instructions may be stored in the form of a program code, and when executed by a processor, the instructions may generate a program module to perform operations of the disclosed embodiments. The recording medium may be implemented non-transitory as a computer-readable recording medium.

The non-transitory computer-readable recording medium may include all kinds of recording media storing commands that can be interpreted by a computer. For example, the non-transitory computer-readable recording medium may be, for example, ROM, RAM, a magnetic tape, a magnetic disc, flash memory, an optical data storage device, etc.

Embodiments of the disclosure have thus far been described with reference to the accompanying drawings. It should be apparent to a person of ordinary skill in the art that the disclosure may be practiced in other forms than the embodiments as described above without changing the technical idea or essential features of the disclosure. The above embodiments are only by way of example and should not be interpreted in a limited sense.

What is claimed is:

1. A vehicle comprising:
a camera disposed in a vehicle to have a plurality of channels and configured to obtain an image from around the vehicle;
a sensing device including an ultrasonic sensor and configured to obtain distance information between an object and the vehicle; and
a controller configured to
match the distance information with the image from around the vehicle,
divide the image from around the vehicle into a plurality of areas,
determine a risk of each of the plurality of areas by matching the object included in the plurality of areas to a predetermined class, and
form a probability map and an occupancy map corresponding to the image from around the vehicle based on the risk.

2. The vehicle according to claim 1, wherein the controller is configured to assign a weight to the object included in the plurality of areas, and to determine the risk based on a weight value.

3. The vehicle according to claim 2, wherein the controller is configured to determine a risk probability corresponding to each area based on a relative risk between the plurality of areas, and to form the probability map based on the risk probability.

4. The vehicle according to claim 3, wherein, when a distance between the vehicle and the object is less than a predetermined distance, the controller is configured to determine the risk probability based on a signal obtained by the ultrasonic sensor.

5. The vehicle according to claim 4, wherein the controller is configured to determine an update cycle of the ultrasonic sensor signal based on position information of the object.

6. The vehicle according to claim 3, wherein the controller is configured to match the risk probability to the image from around the vehicle by corresponding to a predetermined scale.

7. The vehicle according to claim 3, wherein the controller is configured to guide a moving path of the vehicle based on the probability map.

8. The vehicle according to claim 1, wherein the controller is configured to form a top view shape using the occupancy map and the probability map formed corresponding to the image from around the vehicle obtained from each of the plurality of channels of the camera.

9. A method of controlling a vehicle comprising:
obtaining, by a camera having a plurality of channels, an image from around the vehicle;
obtaining, by a sensing device including an ultrasonic sensor, distance information between an object and the vehicle;
matching, by a controller, the distance information with the image from around the vehicle;
dividing, by the controller, the image from around the vehicle into a plurality of areas;
determining, by the controller, a risk of each of the plurality of areas by matching the object included in the plurality of areas to a predetermined class; and
forming, by the controller, a probability map and an occupancy map corresponding to the image from around the vehicle based on the risk.

10. The method according to claim 9, wherein the determining of the risk of each of the plurality of areas comprises:
assigning a weight to the object included in the plurality of areas; and
determining the risk based on a weight value.

11. The method according to claim 10, wherein the forming of the probability map comprises:
determining a risk probability corresponding to each area based on a relative risk between the plurality of areas; and
forming the probability map based on the risk probability.

12. The method according to claim 11, wherein the determining of the risk probability comprises:
when a distance between the vehicle and the object is less than a predetermined distance, determining the risk probability based on a signal obtained by the ultrasonic sensor.

13. The method according to claim 12, further comprising:
determining, by the controller, an update cycle of the ultrasonic sensor signal based on position information of the object.

14. The method according to claim 11, further comprising:
matching, by the controller, the risk probability to the image from around the vehicle by corresponding to a predetermined scale.

15. The method according to claim 11, further comprising:
guiding, by the controller, a moving path of the vehicle based on the probability map.

16. The method according to claim 9, further comprising:
forming, by the controller, a top view shape using the occupancy map and the probability map formed corresponding to the image from around the vehicle obtained from each of the plurality of channels of the camera.
